(19) United States
(12) Patent Application Publication
(10) Pub. No.: US 2008/0105093 A1
(43) Pub. Date: May 8, 2008

(54) Single piece rotary wrenching tool

(76) Inventor: Herbert G. Hart, Sunnyvale, CA (US)

Correspondence Address: PERKINS COIE LLP, P.O. BOX 2168, MENLO PARK, CA, 94026, US

(21) Appl. No.: 11/796,350

(22) Filed: Apr. 26, 2007

Related U.S. Application Data
(60) Provisional application No. 60/797,190, filed on May 2, 2006.

(51) Int. Cl. B25B 13/06; B25B 13/08

(52) U.S. Cl. 81/124.3; 81/124.4; 81/125.1

(57) ABSTRACT

A rotary wrenching tool used on polygonal nuts, bolts and screws is disclosed. More particularly, the wrenching tool is a single piece rotary wrenching tool with a uniform interior having no moving parts and consisting of six or twelve inwardly projecting lobes of the same size that enable the wrench or socket to exert pressure on the flats of hexagonal objects away from the corners. This invention further relates to a duplex wrench operable on hexagonal fasteners measured by the metric, inch, or both systems. Within a defined range in one wrench, each wrench secures hexagonal objects measured by both inch and metric systems.

### CROSS REFERENCE TO RELATED APPLICATIONS

The present application claims priority to U.S. provisional patent application No. 60/797,190 filed May 2, 2006, which is incorporated by reference in its entirety.

### BACKGROUND OF THE INVENTION

For many years, traditional wrenches have been widely used. Traditional wrenches are frequently found inconvenient, inefficient, cumbersome and new wrenches are highly demanded. For instance, wrenches having closed openings with planar engagement surfaces often result in the stress applied to the hexagonal fastener and thus cause deformation of the fastener and inefficient torquing ability. In order to overcome the problems, prior art wrenches having closed openings with curved engagement surfaces were invented. U.S. Pat. No. 4,930,378 Colvin. Although the prior art wrenches are constructed six-point or twelve-point versions, problems with distributing the stresses are not resolved. Furthermore, the twelve-point version is only on either metric or inch system not on duplex system. Ruzicka et al. disclose rotary wrenching tools capable of wrenching fastener heads in various measuring systems. U.S. Pat. No. 5,388,486. Ruzicka et al., however, do not disclose a duplex system for both metric and inch sizes. Heberlie discloses ornamental designs for a double-ended box wrench showing the contour of the wrench heads. U.S. Pat. No. D303,069. The invention, however, discloses a double-ended one-sided crown. As the DIYers encounter an increasing number of metric fastener and diminishing percentage of inch sizes, they are required to have two sets of wrenches both for inch and metric sizes, which are cumbersome, weighty and costly in investment.

### SUMMARY OF THE INVENTION

In various embodiments, one or more of the problems have been reduced or eliminated.

In one embodiment, duplex open end and duplex box wrench are paired. Although the head of the open end is significantly smaller in profile than traditional wrenches, the paired crowns and the tapered internal guide adds tangential strength to the wrench head thereby permitting a slight reduction in the thickness of the wall of the both open and box wrenches. More noticeable is the smaller profile of the open end version, which has jaws that are more blunt than those of conventional wrenches. Although the wrenches are paired, the head is less than twice as thick as traditional wrenches. The tapered internal guide increases the offset quality of both end and box crowns.

In another embodiment, the box crown can be either six or twelve lobes. In one embodiment, the open end has four lobes to contact the fastener and thus distributes the stresses over the four flats of the hex nut. This decreases deformation of the fastener and inefficient torquing ability.

Another advantage of the present invention is compactness. Compactness of the present invention enables the duplex wrench to operate in tighter spaces than most traditional wrenches can do. The present invention also assures optimum contact on and around the hex while the depth of the crowns is minimized. The tapered internal guide prevents the crown from slipping past the hex.

In another embodiment, the lip provides perfect alignment between wrench and hex because of the bottoming out of the hex against the guide.

Another advantage of this single piece rotary wrenching tool with a tapered internal guide is that it provides sufficient space for the shaft of a hex bolt to pass through. The operator can nest a hex nut in the crown of the duplex wrench and carry it to a bolt in a different place to reach or to the underside of an object, making dropped and lost nuts less of a problem. The wide range of hexes that can be accommodated by the duplex set makes these unique tools an appealing, light-weight addition to a handy emergency kit or other tool box. With four sizes on each wrench it is easy to pick the right one for the job. This eliminates the need for the user to gather a bundle of wrenches before beginning a job. The concept of combining double crowns with a tapered internal guide can be applied to other related tools, such as drive socket, crow foot, nut driver, and flare nut and ratchet wrenches.

In another embodiment, two sets of duplex wrenches, both inch and metric, on back to back crowns, provide the DIYers with additional benefits. The pairing of inch and metric sizes dramatically reduces the number of wrenches needed to work on both measuring systems. They are not required to have or carry a toolbox of mixed wrenches. The duplex three pack enables the DIYers to operate on twenty-four metric and inch size hex fasteners. This also minimizes guesswork on choosing the right size wrench. Another advantage of the present invention is that less weight and metal are required in constructing a duplex wrench of the present invention than traditional wrenches.

The above and other objects, features, and advantages of the present invention will become more readily understood and appreciated from a consideration of the following detailed description of the preferred embodiment when taken together with the accompanying drawings, which, however, should not be taken as limitative to the present invention but for elucidation and explanation only.

### BRIEF DESCRIPTION OF THE DRAWINGS

Embodiments of the invention are illustrated in the figures. However, the embodiments and figures are illustrative rather than limiting; they provide examples of the invention.

FIG. 1A depicts a traditional open end wrench.

FIG. 1B depicts a traditional box wrench.

FIG. 2 illustrates a schematic view of a duplex open wrench according to one embodiment of the present invention.

FIG. 3 illustrates a schematic view of a duplex box wrench according to one embodiment of the present invention.

FIGS. 4A, 4B, 4C & 4D depicts a duplex box wrench according to one embodiment of the present invention.

FIG. 5 depicts a duplex wrench according to one embodiment of the present invention.

FIGS. 6A, 6B & 6C depict a schematic view of a duplex box wrench according to one embodiment of the present invention.

FIG. 7A illustrates a profile view of a duplex wrench having both metric and inch sizes according to one embodiment of the present invention.

FIG. 7B illustrates a plain view of the metric and inch sizes contacting lobes of the crown.

FIG. 8 depicts a duplex wrench having inch sizes according to one embodiment of the present invention.

FIG. 9 depicts a duplex wrench having metric sizes according to one embodiment of the present invention.

FIGS. 10A & 10B depicts an open end duplex wrench according to one embodiment of the present invention.

### DETAILED DESCRIPTION OF THE INVENTION

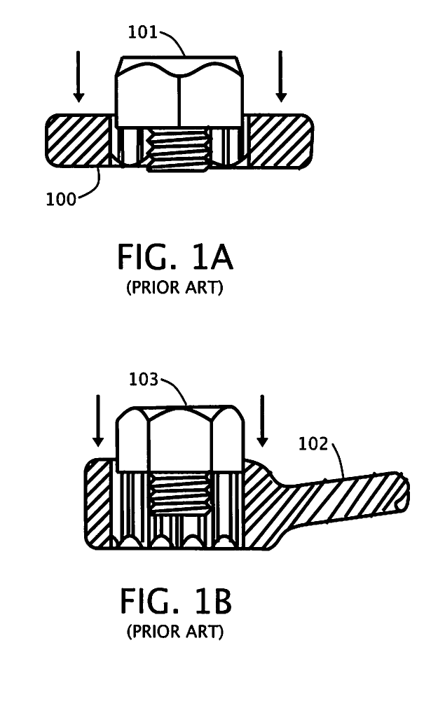

FIG. 1A depicts a traditional open end wrench. A traditional open end wrench 100 slips by when the user applies it on a hex fastener 101.

FIG. 1B depicts a traditional box wrench. A traditional box wrench 102 makes a partial contact with a hex fastener 103.

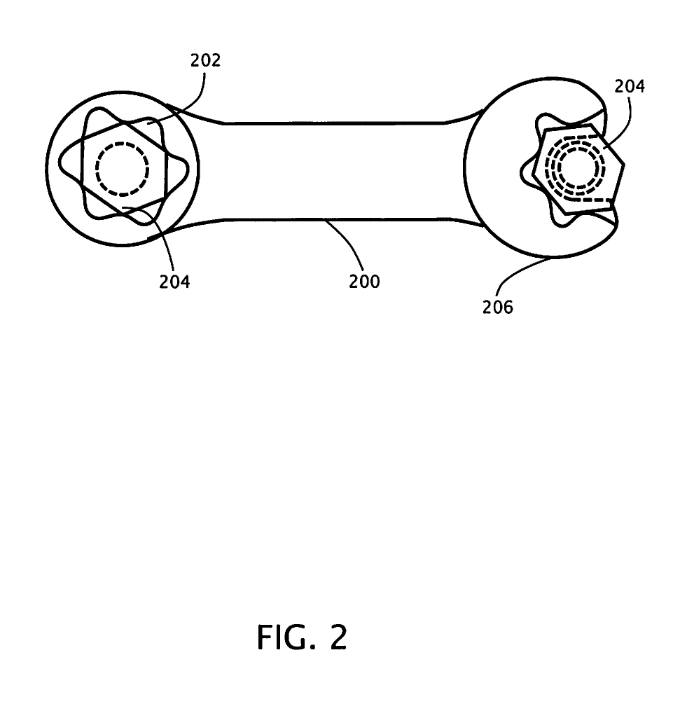

FIG. 2 illustrates a schematic view of a duplex open wrench 200 according to one embodiment of the present invention. In FIG. 2, six inwardly projecting lobes of the same size 202 within a uniform interior of the duplex wrench 200 enable the wrench 200 to exert pressure on the flats of hexagonal object 204 away from the flats. The crown 206 in the duplex open wrench has four faces to contact the hexagonal object 204 and thus distributes the stresses over four hex flats of hexagonal object 204.

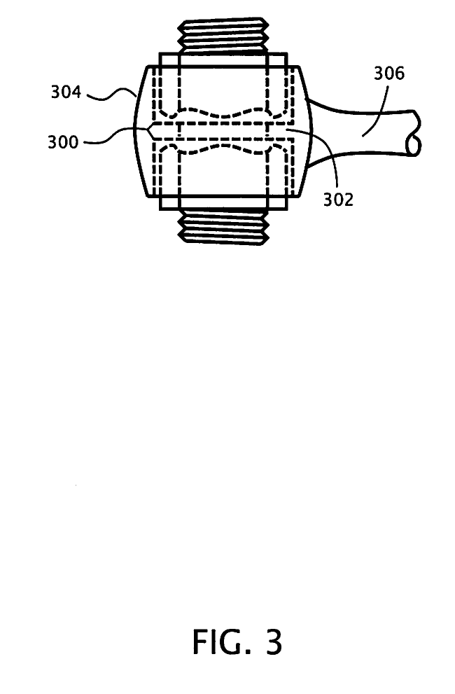

FIG. 3 illustrates a schematic view of a duplex box wrench according to one embodiment of the present invention. A wrench with a two-sided crown 300, a tapered internal guide 302, a head 304, and a shank 306 are disclosed. The paired crowns 300 and the tapered internal guide 302 add strength to the wrench head 304, thereby permitting a slight reduction in the thickness of the wall of the box. The paired crowns 300 act as a basket to carry nuts to remote areas or to inverted bolts. The box crown can be either six or twelve lobes.

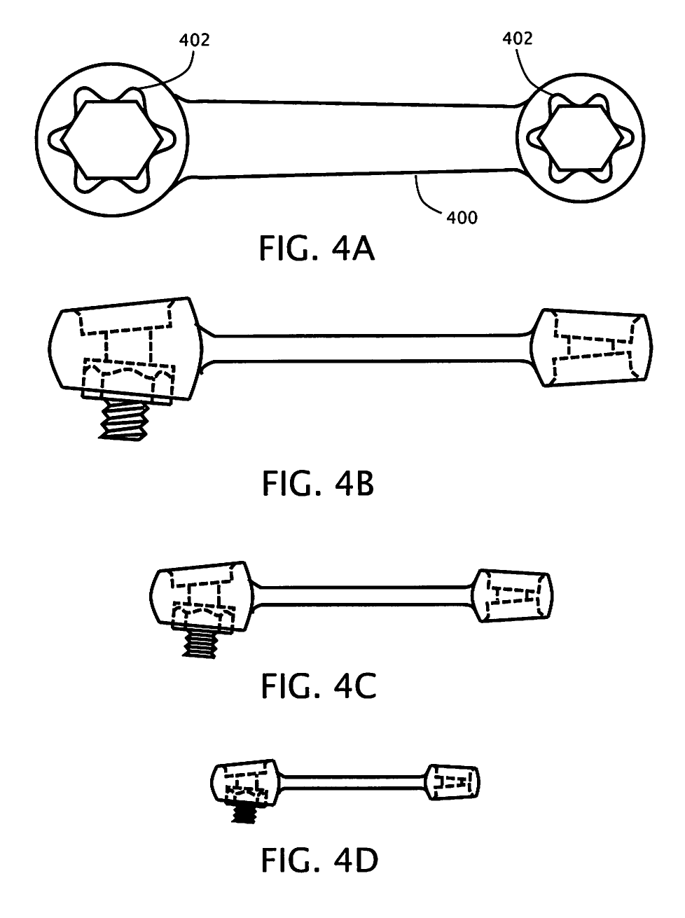

FIG. 4A depicts a schematic view of a duplex box wrench according to one embodiment of the present invention. A wrench with six inwardly projecting lobes of the same size 402 within a uniform interior of the duplex wrench 400 is disclosed.

FIGS. 4B through 4D depict duplex box wrench sets according to the present invention.

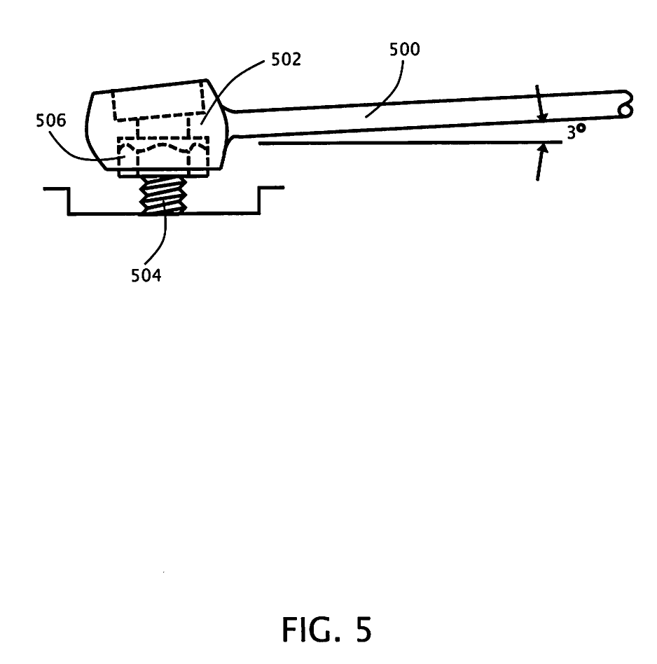

FIG. 5 depicts a duplex wrench 500 according to one embodiment of the present invention. The tapered internal guide 502 increases the offset quality of both box and end crowns. The grip on the hex nut 506 is retained while wrenching a nut on a protruding hex bolt 504. Once contact is made around a hex nut 506 on a protruding bolt 504, the lip 502 keeps the head centered. Ratcheting is done without false torque or tension. One embodiment, by non-limiting example, is that the angle of the of the tapered internal guide angle relative to the shank is 3°.

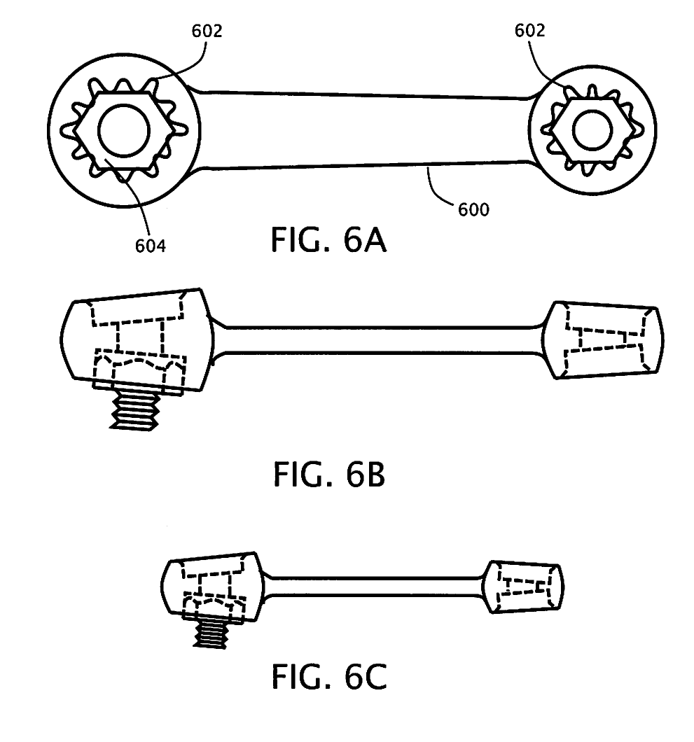

FIG. 6A depicts a schematic view of a duplex box wrench 600 according to one embodiment of the present invention. A wrench with twelve inwardly projecting lobes of the same size 602 within a uniform interior of the duplex wrench 600 is disclosed.

FIGS. 6B through 6D depict duplex box wrench sets according to the present invention.

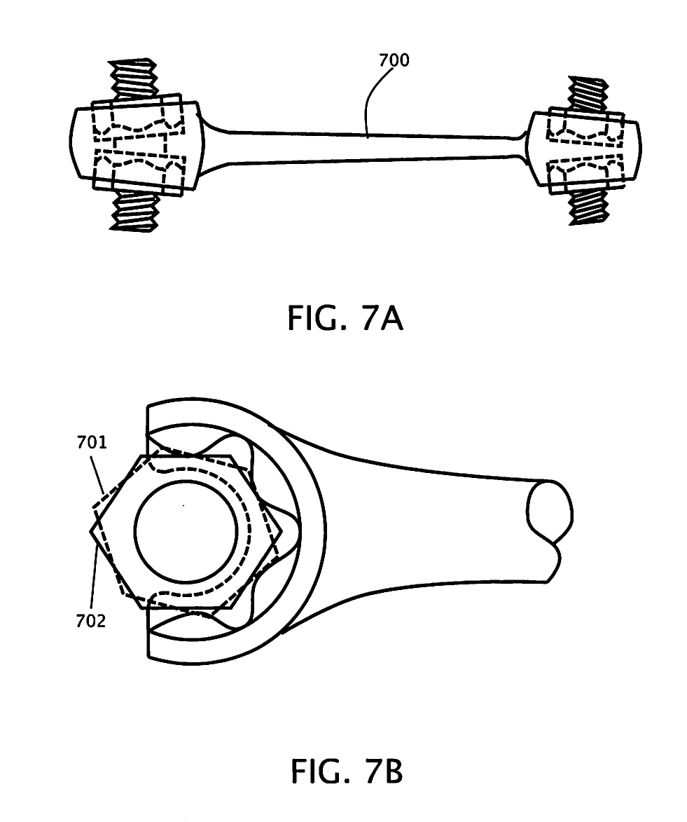

FIGS. 7A & 7B illustrate a duplex wrench 700 having both metric and inch sizes according to one embodiment of the present invention. A duplex wrench for both inch and metric sizes 700 provides additional benefits. The pairing of inch and metric sizes dramatically reduces the number of wrenches needed to work on both measuring systems. For example a hexagonal object 701 measured in inches and a hexagonal object 702 in centimeters can each be worked on by the same duplex wrench.

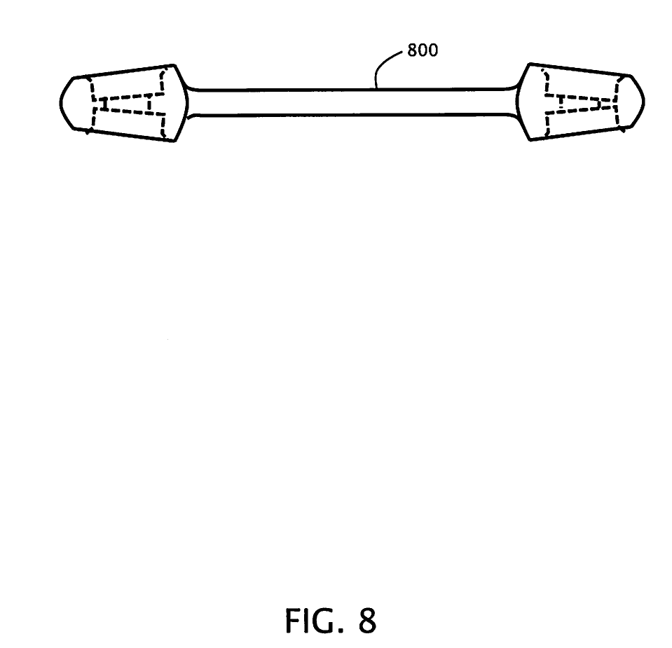

FIG. 8 depicts a duplex wrench 800 measured in inch sizes according to one embodiment of the present invention. A set of different inch sizes will dramatically reduce the number of wrenches needed to work on inch measuring system.

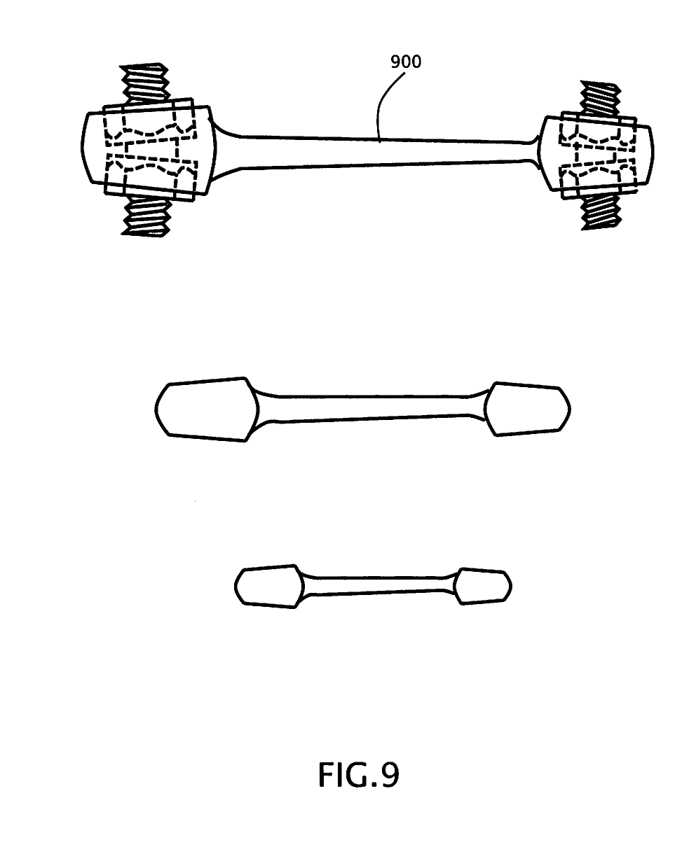

FIG. 9 depicts a duplex wrench 900 measured using the metric system according to one embodiment of the present invention. A set of different metric sizes will dramatically reduce the number of wrenches needed to work on metric measuring system.

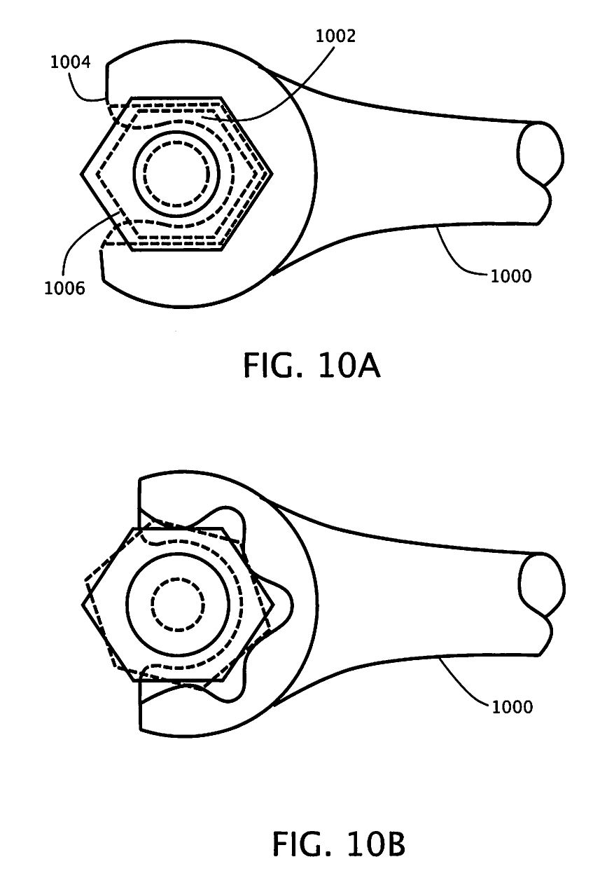

FIGS. 10A & 10B depict an open end duplex wrench 1000 according to one embodiment of the present invention. A tapered internal guide 1002 and jaws with blunt nose 1004 are disclosed. The blunt nose 1004 provides tangential strength to the wrench head when the wrench applies on the hex nut 1006.

It will be appreciated by those skilled in the art that the preceding examples and preferred embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention.

What is claimed is:

1. A single piece rotary wrenching tool, comprising:
a shank;
a head connected to the shank having a uniform interior without moving parts;
a tapered internal guide inside the head separating the interior of the head into a two sided crown;

2. The single piece rotary wrenching tool of claim 1, further comprising:
twelve inwardly projecting lobes at the crown enable the wrench or socket to exert pressure on the flats of a hexagonal object.

3. The single piece rotary wrenching tool of claim 1, wherein six inwardly projecting lobes enable the wrench or socket to exert pressure on the flats of a hexagonal object having corners away from the corners.

4. The single piece rotary wrenching tool of claim 1, wherein the two sided crown is formed by two joined heads of different sizes.

5. The single piece rotary wrenching tool of claim 1, wherein the head is raised to provide an offset quality.

6. The single piece rotary wrenching tool of claim 1, wherein the tapered internal guide provides sufficient space for the shaft of a hexagonal bolt to pass through.

7. The single piece rotary wrenching tool of claim 1, wherein the tapered internal guide provides constant optimal contact on a hexagonal object.

8. The single piece rotary wrenching tool of claim 1, wherein the tapered internal guide maintains the head centered over a hexagonal object while ratcheting a nut on a protruding bolt.

9. The single piece rotary wrenching tool of claim 1, wherein the two sided crown further comprises:
a first side having an angle of tilt relative to the shank.

10. The single piece rotary wrenching tool of claim 9, wherein the angel of tilt is three degrees.

11. A duplex box wrench, comprising:
a first head having a first two sided crown, a uniform interior and a first tapered internal guide;
a second head having a second two sided crown, a uniform interior and a second tapered internal guide;
a shank connecting the first head and the second head;

12. The duplex box wrench as in claim 11, wherein the first two sided crown has six lobes.

13. The duplex box wrench as in claim 11, wherein the duplex box wrench is measured using the metric system.

14. The duplex box wrench as in claim 11, wherein the duplex box wrench is measured in inches.

15. The duplex box wrench as in claim 11, wherein the duplex box wrench is measured in both inches and using the metric system.

16. The duplex box wrench as in claim 11, wherein the first two sided crown has a first side having a three degree tilt relative to the shank.
